(19) United States
(12) Patent Application Publication
(10) Pub. No.: US 2017/0313340 A1
(43) Pub. Date: Nov. 2, 2017

(54) VISIBILITY ALERT SYSTEM FOR A BABY STROLLER AND OTHER MEANS OF BABY GROUND TRANSPORTATION

(71) Applicant: Liliane Stransky, Aventura, FL (US)

(72) Inventor: Liliane Stransky, Aventura, FL (US)

(21) Appl. No.: 15/499,717

(22) Filed: Apr. 27, 2017

Related U.S. Application Data
(60) Provisional application No. 62/328,123, filed on Apr. 27, 2016.

(51) Int. Cl. B62B 9/00

(52) U.S. Cl. CPC B62B 9/005

(57) ABSTRACT

A handcart safety system for a baby stroller other means of baby ground transportation that has a telescoping pole with a visibility aid and flag at its distal end and a clamp at its proximal end. The visibility aid is a bright light or similar device for drawing attention from an object approaching the stroller or baby transportation means. The flag may be extendable and collapsible, may have bright colors to draw attention, and may include messages, or be otherwise customized and adapted. The pole may be attached to a clamp using a pivoting joint or other device to adjust the orientation of the pole relative to a stroller or means of baby ground transportation to which it is attached. The safety system may be formed integral with a baby stoller or may be detachable.

### CROSS-REFERENCE TO RELATED APPLICATIONS

This application claims priority to U.S. Provisional Application Serial No. 62/328,123 filed on Apr. 27, 2016, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

### Field of the Invention:

The present invention relates to a handcart safety system for baby strollers and other means of baby ground transportation. For example, but not limited to bicycle side cars, stroller bicycles, and family bicycles. More particularly, the invention relates to a visibility system utilizing lights, flags or other objects for substantially enhancing the visibility of a baby stroller.

### Description of the Related Art:

Drivers of automobiles and other vehicles encounter many signs, directions, obstacles and objects to avoid on any traffic route. It may often be difficult to notice every object or sign, especially in high volume traffic areas and large cities. This is true at night when it is more difficult to identify every object a driver should be aware of, and also during the daytime amidst the many distractions on route in public places.

Pedestrian crossings are an especially dangerous part of the roadways. Many steps of been taken to make them safer. Extra lighting, crossing signals, white lines across a pathway and LED flashing lights have all been used. Nonetheless, it is not always easy to identify pedestrians from a distance.

Parents are perhaps most aware of the particular dangers posed by vehicles and traffic to very small children. As a result, some signage has been created to improve child safety. For example, signs have been created to place on or near a roadway to advise of children playing. However, little has been done to improve the visibility of a baby stroller. Baby strollers are particularly susceptible because of their limited mobility and small size. A baby stroller is not easily quickly grabbed and pulled away from a hazard. They also do not resemble the profile of a human and are easily mistaken for unimportant or insignificant objects, particularly by passing drivers.

In view of the foregoing, it is important to provide devices, systems and methods for improving the visibility of a baby stroller to ongoing traffic, pedestrian areas, pedestrian crossings, and in other public places of heavy and busy activity, distractions, and poor visibility.

### BRIEF SUMMARY OF THE INVENTION

Disclosed is a device for attachment to a baby stroller or other device that substantially increases its visibility to other persons, vehicular traffic and other observers.

In one embodiment, a handcart safety system for an infant stroller comprises a telescoping pole, having a visibility aid at its distal end and a flag hanging from a side-arm rotatable from parallel to perpendicular to the pole. The base of the pole has an adjustable clamp to fit onto many strollers and other means of baby ground transportation. The alert system may be used with an infant stroller, a handcart, a carriage, a wagon or the like. The handcart safety system may allow rotation of the clamp relative to the pole. The handcart safety system is collapsible so that it easily fits into a small carrying case similar to a small travel umbrella.

It is therefore an object of the present invention to provide a highly portable device for increasing visibility of a baby stroller and other means of baby ground transportation, thereby increasing child safety.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an environmental perspective view of a handcart safety system in accordance with the principles of the invention;

FIG. 2 is a front elevation view of an extended handcart safety system in accordance with principles of the invention;

FIG. 3 is a front elevation view of a collapsed handcart safety system in accordance with the principles of the invention;

FIG. 4 is a front elevation view of a collapsed handcart safety system in accordance with the principles of the invention;

FIG. 5 is a side elevation view of a collapsed handcart safety system in accordance with the principles of the invention;

FIG. 6 is a side elevation view of a collapsed handcart safety system in accordance with the principles of the invention;

FIG. 7 is a side elevation view of an alternative embodiment of a handcart safety system in accordance with principles of the invention;

FIG. 8 is a front elevation view of an alternative embodiment of a handcart safety system in accordance with principles of the invention;

FIG. 9 is an environmental view of another alternative embodiment of a handcart safety system in accordance with the principles of the invention;

FIG. 10 is an environmental view of another alternative embodiment of a handcart safety system in accordance with the principles of the invention;

FIG. 11 is a perspective view of another alternative embodiment of a handcart safety system in accordance with the principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein.

For clarity and convenience, some exemplary embodiments are described using the terms “stroller” and “baby stroller.” This is not intended to be limiting. “Stroller” is generally synonymous with “handcart,” “sled,” “baby carriage,” “pram,” and “perambulator.” It is also contemplated that a safety system in accordance with the principles of the invention may be applied to many other wheeled devices, such as wheelchairs, gurneys, wagons and the like.

The term “visibility aid” generally refers to any device or mechanism that may be utilized to draw the attention of persons in the vicinity to an object. Visibility aids are therefore contemplated to include reflectors, lights, illuminating devices, beacons, klaxons, LED screens, flags, streamers, banners or other devices designed to make persons in the general vicinity aware of the presence of an object.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Disclosed is a handcart safety system for a baby stroller and other means of baby ground transportation that increases the visibility of a baby stroller, hand cart or similar device during the day and at night, thereby increasing the safety of a child within the stroller, particularly in the vicinity of vehicular traffic and in busy and crowded public spaces.

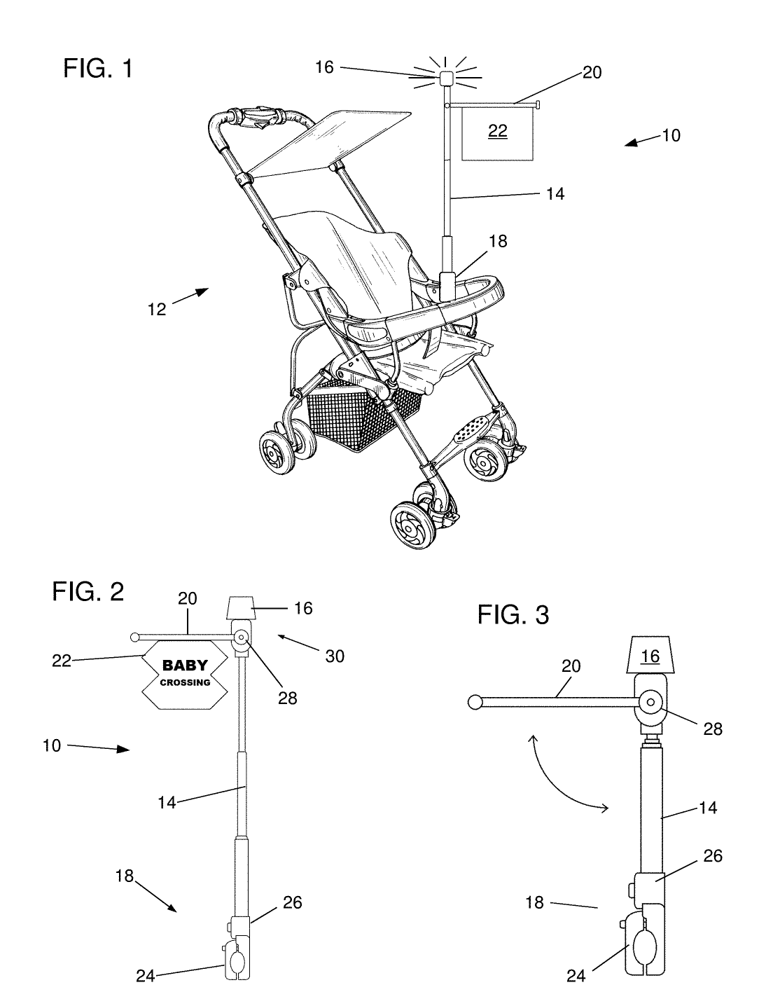

FIGS. 1 shows an exemplary embodiment of a handcart safety system 10 in accordance with the principles of the invention. The handcart safety system 10 is removably affixed to a baby stroller 12. The handcart safety system 10 includes a telescoping pole 14 having a visibility aid 16 at its distal end and a pivoting clamp 18 at its proximal end. In this embodiment, the visibility aid 16 comprises a light beacon. A pivoting side arm 20 near the distal end may support a flag 22 suspended from it.

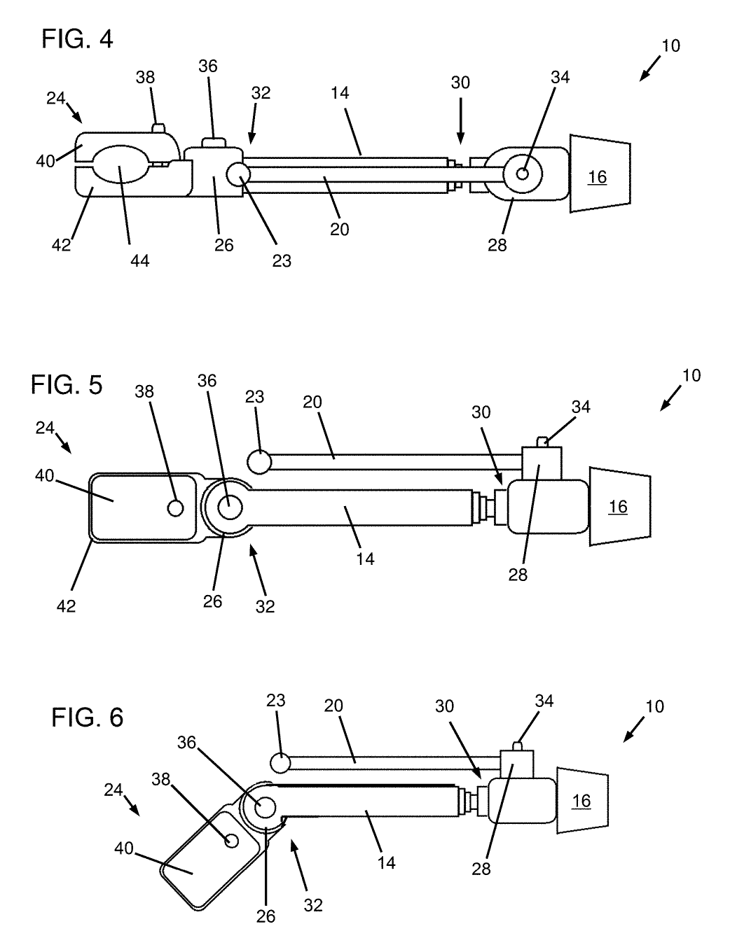

FIGS. 2-6 show the handcart safety system 10 in more detail. The side arm 20 is affixed to the distal end 30 of the telescoping pole 14 by a pivot joint 28 that allows the side arm 20 to be positioned either parallel with or perpendicular to the telescoping pole 14. The pivot joint 28 includes a locking mechanism that holds the side arm 20 in a desired configuration. The pivoting clamp 18 is located at the proximal end 32 of the telescoping pole 14 and includes a pivot mechanism 26 and an adjustable clamp 24. The individual segments of the telescoping pole 14 may generally remain in the same orientation relative to each other due to friction fit between the segments. However, the segments may be rotated relative to one another by applying sufficient torque force. This allows the side arm 20 to be aligned in any direction relative to a stroller 12 or similar handcart. For example, the side arm 20 may be aligned parallel with or transverse to the direction of travel.

The visibility aid 16 is located at the distal end 30 of the telescoping pole 14. The visibility aid 16 may be at the most distal end of the alert system 10 or may optionally be affixed at another location. It may be preferable to position the visibility aid 16 at the highest point of the alert system 10 in order to maximize visibility. The visibility aid 16 may be a simple light, or may optionally be a klaxon or a light comprised of several LEDs capable of blinking or changing color in a variety of patterns. The visibility aid 16 may optionally have its own control mechanisms for adjusting the speed, lighting sequence or other parameters of the visibility aid itself. The visibility aid 16 may optionally be controlled by a control mechanism incorporated into the visibility aid 16, to another location on the alert system 10 or may be controlled remotely using a telephone application and a short range communication system, for example Bluetooth.

The telescoping pole 14 may optionally be comprised of a pole having separate independent components that may be affixed separately. Generally, however, a telescoping pole is the most efficient and easiest to use. Optionally, the pole 14 may be fixed and not telescoping. However, it is generally preferable to use a telescoping pole so that when it is not in use it may be stored more efficiently. The side arm 20 has a length that is less than the total length of the alert system when the pole 14 is collapsed. This may also simplify storage. However, the side arm 20 may optionally have a longer or shorter length than is shown in the figures.

The mounting clamp 18 is located at the proximal end of the pole 14 and includes an adjustable clamp 24. In this embodiment, the clamp 24 includes two opposing grips 40 and 42 that form a cavity 44 and sized to grip an arm or Rod on a stroller, hand cart or other device as shown in FIG. 1. Because a Rod, arm or other component of a stroller may not extend in a substantially horizontal direction, the mounting clamp 18 includes a pivoting mechanism 26. Pivoting mechanism 26 allows the pole 14 to be adjusted into several different orientations relative to the clamp 24. As a result, the pole 14 may be rotated into a preferred orientation and the visibility aid 16 extended to a maximum practical height. The mounting clamp 18 may optionally include other rotating mechanisms, such as providing rotation about an axis parallel to the pole 14. Many telescoping poles inherently provide rotation on this axis and therefore additional components may be unnecessary. In this embodiment, the mounting clamp 18 includes a button 36 for actuating the pivoting mechanism 26 and locking it when the pole 14 and clamp 24 are in a desired configuration. Clamp 24 includes an adjusting knob 38 that allows an operator to loosen or tighten the clamp 24. Clamp 24 is intended to be exemplary and those skilled in the art will appreciate that a wide variety of other mechanisms may be used to affix the alert system to a device such as a stroller, handcart, or other means of baby ground transportation. Optionally, the side arm 20 may also be telescoping and may optionally include a removable knob 23 that may allow different flags to be readily and interchangeably affixed to the arm 20.

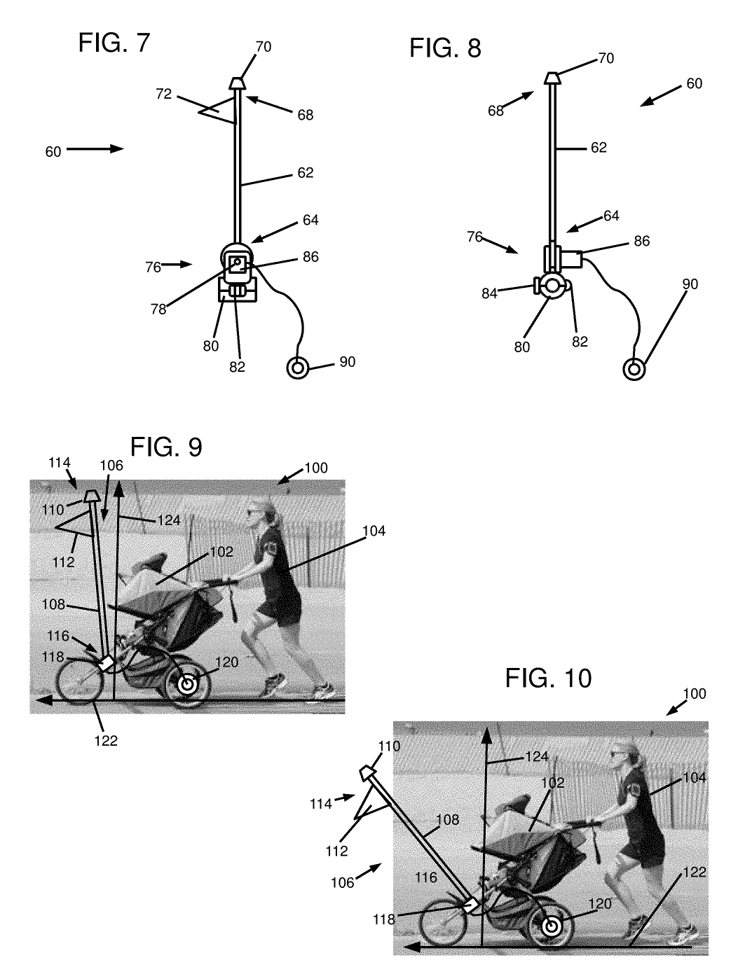

FIGS. 7 and 8 show an alternative embodiment of a handcart safety system 60 in accordance with the principles of the invention. The safety system 60 includes a pole 62 having a proximal end 64 and a distal end 68. The distal end 68 has a primary visibility aid 70 and may optionally include a secondary visibility aid 72. In this embodiment, the secondary visibility aid 72 is a flag or pennant. The primary visibility aid 70 is a light whose luminescence may be adjusted in brightness and sequence. The safety system 60 also includes a base 76 at the proximal end 64 of the pole 62. A pivot pin 78 connects the proximal end 64 to the base 76 and allows the pole 62 to rotate and thereby change its orientation relative to a stroller or other device.

The base 76 includes an adjustable clamp 80 having a hinge 82 that allows it to swing open and a lock 84, such as a latch, to secure the clamp in place at a desired location on a stroller or other device. Other mechanisms for attaching the base 76 to a handcart, such as for example the clamp shown in the previous Figures, may also be suitable. Those skilled in the art will appreciate that there are a wide variety of fasteners suitable for attaching the base 76 to a stroller, hand cart or similar device.

The base 76 also includes a motor 86 configured to pivot the proximal end 64 of the pole 62 about the pivot pin 78, thereby rotating the pole 62. The motor 86 is controlled by a speedometer 90. In this embodiment, the speedometer 90 is affixed to one of the axles of a stroller to which the safety system 60 is attached. The speedometer 90 determines the speed of a stroller or handcart by detecting the revolutions of the axle to which it is attached. Those skilled in the art will appreciate that such speedometers are well known have been in use for some time. Optionally, other types of speedometers may be used.

When the speedometer 90 detects forward motion of the stroller, it actuates the motor 86 to rotate the pole 62 a predetermined amount in the forward direction, thereby adjusting the orientation of the pole 62 to a stroller. For example, when a stroller is stationary, the pole may extend upward vertically, perpendicular to the direction of motion. As should be clear to those skilled in the art, the direction of motion is horizontal and generally forward and backward. When the stroller is in motion at a slow pace, the speedometer 90 causes the motor 86 to rotate the pole 62 slightly forward. That is, the angle between the direction of motion and the pole 62 will change from 90° to some predetermined angle less than 90° . As the speed of the stroller increases, the angle between the direction of motion in the pole 62 will decrease. Conversely, as the speed decreases, the angle between the direction of motion and the pole 62 will increase. When the stroller is moved in a backward direction, the 62 pole rotates backward.

By adjusting the angle of the pole 62 according to the speed of the stroller, safety is improved. During the night, when it is dark outside, operators of vehicles may only clearly see the light 70 at the distal end 68 of the pole 62. Observers may not realize the actual dimensions of a stroller and its location relative to the light 70. When the stroller is moving, it is generally more important for observers to remain clear of the forward region of the stroller and the region directly in front of the stroller. By rotating the pole 62 by an amount relative to the speed of the stroller, the light 70 focuses an observer's attention to the forward end of the stroller. This may be particularly beneficial with strollers designed to be pushed by persons who are jogging and may be moving relatively quickly.

FIGS. 9 and 10 show a method of improving safety 100 that is similar to the security system 60 shown in FIGS. 7 and 8. A stroller 102 is being utilized by an operator 104. A safety system 106 has been incorporated into the stroller 102. The safety system 106 includes a pole 108 having a primary visibility aid 110 and a secondary visibility aid 112 at its distal end 114. The proximal end 116 of the pole 108 is pivotally attached to a base 118. A speedometer 120 measures the speed of the stroller 102, and actuates a motor in the base 118 to pivot the pole 108.

In FIG. 9, the operator 104 is pushing the stroller 102 at a relatively slow pace in the direction of motion 122. Because the speedometer 120 detects a slow pace, the pole 108 has been rotated only a few degrees in the direction of motion 122 and away from a vertical direction 124 perpendicular to the direction of motion 122. If the speed of the stroller 102 is kept constant, the pole 108 will remain oriented at this angle. FIG. 10 shows the safety system 106 after the operator 104 has accelerated to a new, higher constant speed. The speedometer 120 detects the new speed and adjusts the orientation of the pole 106 so that it forms a smaller angle with the direction of motion 122. The speedometer 120 and/or the motor may be calibrated by an operator to adjust the degrees of rotation relative to speed. The operator 104 may also optionally observe the safety system 106 monitor his or her own speed and/or workout intensity.

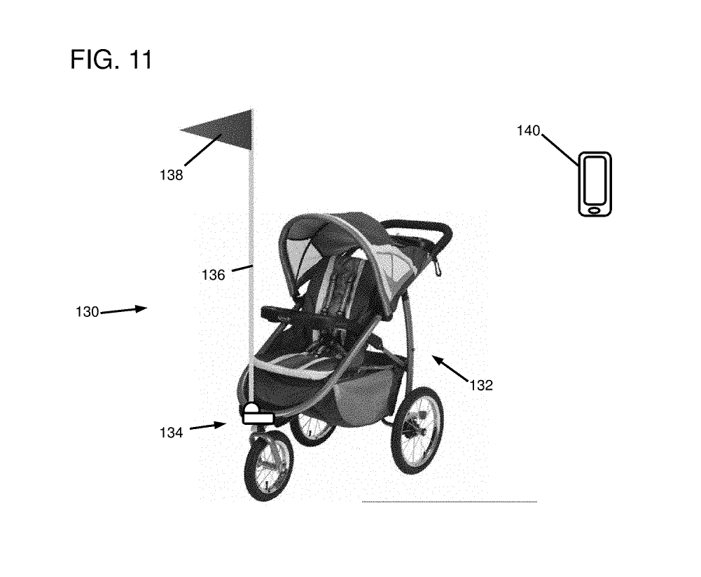

FIG. 11 shows an alternative embodiment of a safety system 130 in accordance with the principles of the invention. The safety system 130 is affixed to a stroller 132 at its base 134. In this embodiment, the safety system 130 is integral with the stroller 132. Optionally, the safety system 130 may be detachable from the stroller 132. A pole 136 extends upward from the base 134 and has a visibility aid 138. In this embodiment, the visibility aid 138 is a flag. The safety system 130 includes a transmitter for sending and receiving signals to an electronic device 140. In this embodiment, the electronic device 140 is a cell phone. Signals may be sent and received via Wi-Fi, Bluetooth®, radio waves or electrical wires. The cell phone 140 includes software that allows an operator to adjust the angle by which the pole 136 is rotated relative to the speed of the stroller 132. The cell phone 140 also includes a speedometer and sends information relating to the speed of the stroller 132. The safety system 130 received this information and pivots the pole 136 in relation to the speed detected by the cell phone 140. Optionally, the software utilized by the phone 140 may be used to gather information to improve operation of the safety system 130.

Whereas, the present invention has been described in relation to the drawings attached hereto, other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A handcart safety system for a stroller, hand cart, or other means of baby ground transportation, comprising
a telescoping pole;
a visibility aid at a distal end of the pole;
a flag hanging from side-arm rotatable from parallel to perpendicular to pole; and,
a base at a proximal end of the pole and having a clamp rotatable relative to pole.

2. The handcart safety system for a stroller or hand cart of claim 1 wherein the hand cart comprises an infant stroller, baby carriage, or other means of baby ground transportation.

3. The handcart safety system for a hand cart of claim 1 wherein the axis of rotation of the clamp relative to the pole is substantially perpendicular to an object positioned between a first grip and second grip of the clamp, or other area of the stroller or hand cart that allows the pole to be substantially perpendicular to the cart, or otherwise extended for increased visibility.

4. A handcart safety system comprising:
a pole having a proximal end, and a distal end;
at least one visibility aid at the distal end of the pole; and,
a fastener connecting the proximal end of the pole to a handcart.

5. The hand cart safety system of claim 4 wherein the visibility aid is a flag, a light, or a flag and a light.

6. The handcart safety system of claim 5 wherein the pole has an adjustable length.

7. The handcart safety system of claim 6 wherein the pole is a telescoping pole.

8. The handcart safety system of claim 7 wherein the orientation of the pole relative to the handcart is adjustable.

9. The handcart safety system of claim 8 wherein the fastener provides an axis of rotation at the proximal end of the pole about which the pole rotates relative to the handcart.

10. The handcart safety system of claim 9 wherein a friction fit lock that allows the pole to rotate when the lock is loosened and holds the pole in a constant orientation to the handcart when the lock is tightened.

11. The handcart safety system of claim 10 further comprising a speedometer that actuates a motor to rotate the pole such that the angle between the pole and the direction of travel decreases as velocity increases.
